(19) United States
(12) Patent Application Publication
(10) Pub. No.: US 2013/0117157 A1
(43) Pub. Date: May 9, 2013

(54) OPTIMALLY SOURCING SERVICES IN HYBRID CLOUD ENVIRONMENTS

(71) Applicants: Ilyas Iyoob, Austin, TX (US); Emrah Zarifoglu, Austin, TX (US); Manish Modh, Cedar Park, TX (US); Mohammed Farooq, Austin, TX (US)

(72) Inventors: Ilyas Iyoob, Austin, TX (US); Emrah Zarifoglu, Austin, TX (US); Manish Modh, Cedar Park, TX (US); Mohammed Farooq, Austin, TX (US)

(73) Assignee: GRAVITANT, INC., Austin, TX (US)

(21) Appl. No.: 13/292,791

(22) Filed: Nov. 9, 2011

(51) Int. Cl. G06Q 30/06

(52) U.S. Cl. 705/26.41

(57) ABSTRACT

A method, system and computer program product for selecting the optimal cloud service provider(s) to service a user's needs. A physical capacity of servers in a non-virtualized data center is converted into a cloud capacity to be used. A list of cloud service providers may be generated from a catalog of providers based on the cloud capacity to be used. Additional requirements and constraints received from the user are used to select an optimal cloud service provider(s) from the generated list of cloud service providers.

### TECHNICAL FIELD

The present invention relates to cloud computing, and more particularly to selecting the optimal cloud service provider(s) to service the user's needs.

### BACKGROUND

In general, the concepts of “virtual” and “cloud computing” include the utilization of a set of shared computing resources (e.g., servers) which are typically consolidated in one or more data center locations. For example, cloud computing systems may be implemented as a web service that enables a user to launch and manage computing resources (e.g., virtual server instances) in third party data centers. In a cloud environment, computer resources may be available in different sizes and configurations so that different resource types can be specified to meet specific needs of different users. For example, one user may desire to use a small instance as a web server and another user may desire to use a larger instance as a database server, or an even larger instance for processor intensive applications. Cloud computing offers this type of outsourced flexibility without having to manage the purchase and operation of additional hardware resources within an organization.

A cloud-based computing resource is thought to execute or reside somewhere on the “cloud,” which may be an internal corporate network or the public Internet. From the perspective of an application developer or information technology administrator, cloud computing enables the development and deployment of applications that exhibit scalability (e.g., increase or decrease resource utilization as needed), performance (e.g., execute efficiently and fast), and reliability (e.g., never, or at least rarely, fail), all without any regard for the nature or location of the underlying infrastructure.

Currently, a cloud service provider (provides the cloud computing service) is selected by a user based on the current physical capacity (e.g., storage capacity, network bandwidth capacity, compute capacity) to service the user's required needs/requirements without considering the utilization of those resources as well as all other services in the cloud. That is, the required cloud capacity is assumed to correspond to the current physical capacity which may be manually estimated and the first cloud service provider that satisfies such capacity requirements is selected without any standardized comparison among the various cloud service providers. As a result, the selected cloud service provider(s) may not be the optimal cloud service provider(s), whether in terms of pricing, quality of service, agility, resource provisioning, etc.

### BRIEF SUMMARY

In one embodiment of the present invention, a method for selecting the optimal cloud service provider(s) to service a user's needs comprises converting a physical capacity of servers in a non-virtualized data center into a cloud capacity. The method further comprises pricing the cloud capacity based on a catalog of providers to generate a list of cloud service providers that is standardized. Additionally, the method comprises simulating the list of cloud service providers. Furthermore, the method comprises receiving constraints on one or more of costs, agility and quality of service. The method additionally comprises selecting, by a processor, via an optimization algorithm one or more cloud service providers from the list of cloud service providers based on the received constraints. In addition, the method comprises recalibrating the selection of one or more cloud service providers from the list of cloud service providers.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates the hardware configuration of a computer system for practicing the principles of the present invention;

FIG. 2 is a diagram illustrating the macro process for selecting the optimal cloud service provider(s) to service the user's needs in accordance with an embodiment of the present invention;

FIG. 3 illustrates the software architecture used for selecting the optimal cloud service provider(s) to service the user's needs in accordance with an embodiment of the present invention;

FIG. 4 is a flowchart of a method for converting the physical capacity into a cloud capacity in accordance with an embodiment of the present invention;

FIGS. 5A-5B are a flowchart of a method for determining a preferred list of cloud service providers that satisfy the user's requirements and preferences in accordance with an embodiment of the present invention; and

FIG. 6 is a flowchart of a method for identifying the best cloud service provider from the preferred list of cloud service providers applying the user's goals and constraints in accordance with an embodiment of the present invention.

### DETAILED DESCRIPTION

In the following description, numerous specific details are set forth to provide a thorough understanding of the present invention. However, it will be apparent to those skilled in the art that the present invention may be practiced without such specific details. For the most part, details considering timing considerations and the like have been omitted inasmuch as such details are not necessary to obtain a complete understanding of the present invention and are within the skills of persons of ordinary skill in the relevant art.

The principles of the present invention discussed herein may be applied to many different types of architectures, including physical, cloud and hybrid. To be clear, a hybrid architecture is a collection of information technology resources that conform to an application architecture where the processing of application demand is split between two or more types of architectures. For example, some organization might choose to have a physical/cloud hybrid architecture where some of their old single tenant applications run on their existing physical architecture while they transition to the new cloud architecture.

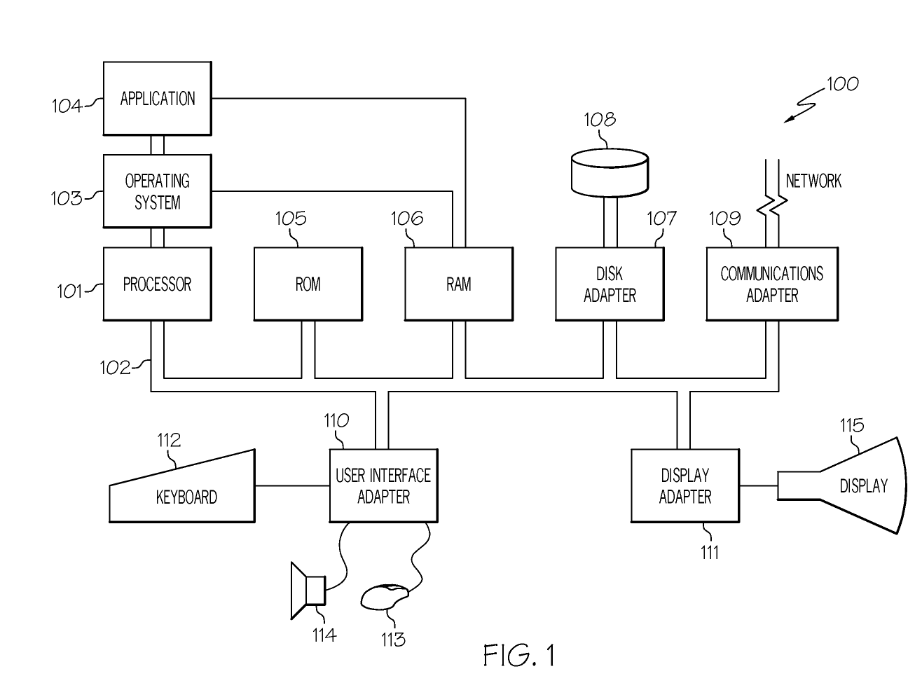

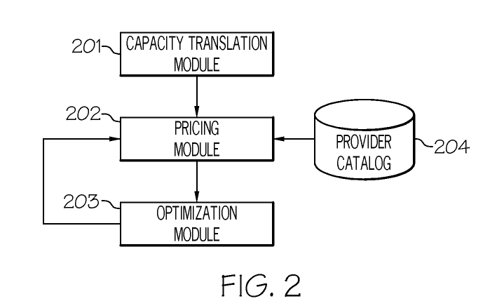

Referring now to the Figures in detail, FIG. 1 illustrates a hardware configuration of a computer system 100 which is representative of a hardware environment for practicing the present invention. Referring to FIG. 1, computer system 100 has a processor 101 coupled to various other components by system bus 102. An operating system 103 runs on processor 101 and provides control and coordinates the functions of the various components of FIG. 1. An application 104 in accordance with the principles of the present invention runs in conjunction with operating system 103 and provides calls to operating system 103 where the calls implement the various functions or services to be performed by application 104. Application 104 may include, for example, a program for selecting the optimal cloud service provider(s) to service the user's needs as discussed further below in association with FIGS. 2-6.

Referring again to FIG. 1, read-only memory (“ROM”) 105 is coupled to system bus 102 and includes a basic input/output system (“BIOS”) that controls certain basic functions of computer system 100. Random access memory (“RAM”) 106 and disk adapter 107 are also coupled to system bus 102. It should be noted that software components including operating system 103 and application 104 may be loaded into RAM 106, which may be computer system's 100 main memory for execution. Disk adapter 107 may be an integrated drive electronics (“IDE”) adapter that communicates with a disk unit 108, e.g., disk drive. It is noted that the program for selecting the optimal cloud service provider(s) to service the user's needs, as discussed further below in association with FIGS. 2-6, may reside in disk unit 108 or in application 104.

Computer system 100 may further include a communications adapter 109 coupled to bus 102. Communications adapter 109 interconnects bus 102 with an outside network enabling computer system 100 to communicate with other devices.

I/O devices may also be connected to computer system 100 via a user interface adapter 110 and a display adapter 111. Keyboard 112, mouse 113 and speaker 114 may all be interconnected to bus 102 through user interface adapter 110. Data may be inputted to computer system 100 through any of these devices. A display monitor 115 may be connected to system bus 102 by display adapter 111. In this manner, a user is capable of inputting to computer system 100 through keyboard 112 or mouse 113 and receiving output from computer system 100 via display 115 or speaker 114.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, currently, a cloud service provider (provides the cloud computing service) is selected by a user based on the current physical capacity (e.g., storage capacity, network bandwidth capacity, compute capacity) to service the user's required needs/requirements without considering the utilization of those resources as well as all other services in the cloud. That is, the required cloud capacity is assumed to correspond to the current physical capacity which may be manually estimated and the first cloud service provider that satisfies such capacity requirements is selected without any standardized comparison among the various cloud service providers. As a result, the selected cloud service provider(s) may not be the optimal cloud service provider(s), whether in terms of pricing, quality of service, agility, resource provisioning, etc.

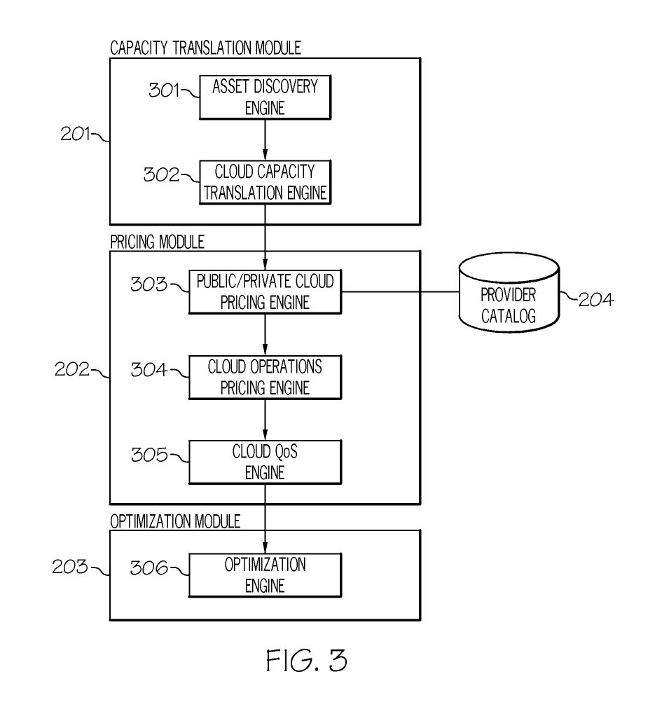

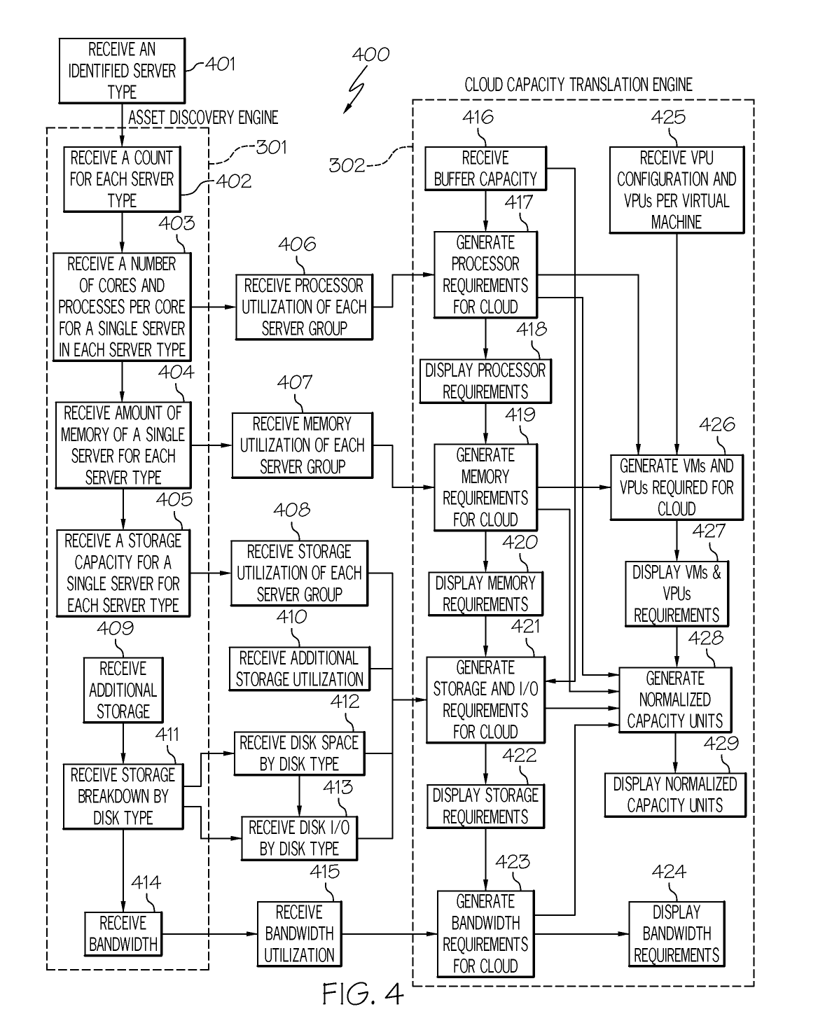

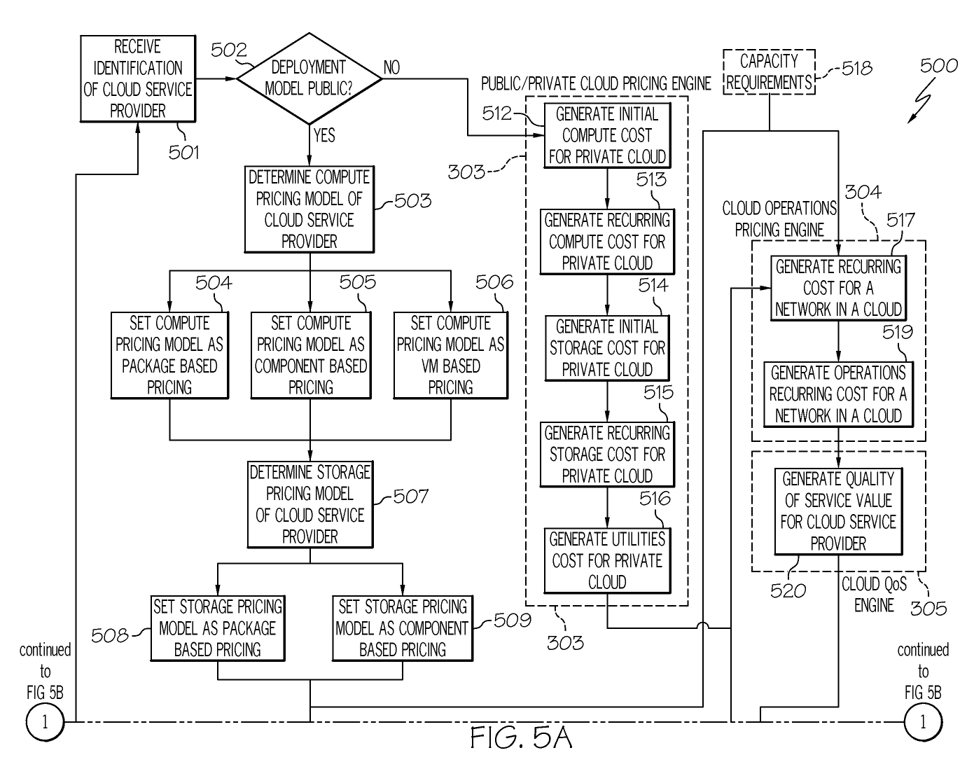

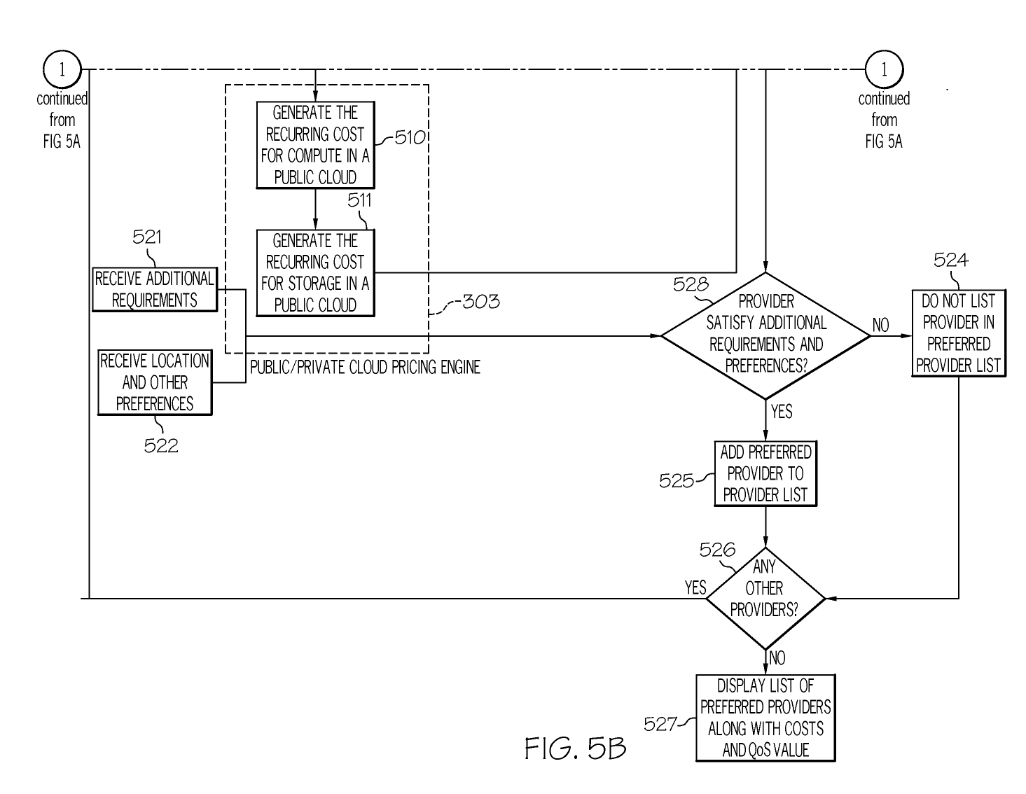

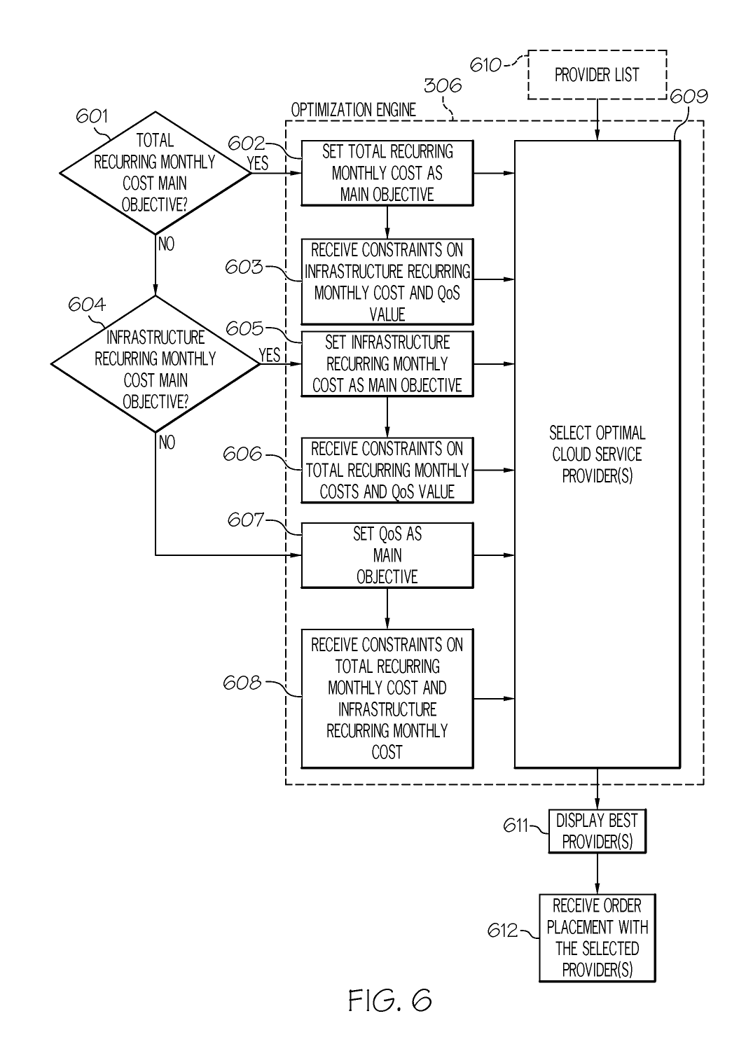

The principles of the present invention provide a tool for selecting the optimal cloud service provider(s) to service the user's needs as discussed below in connection with FIGS. 2-6. FIG. 2 is a diagram illustrating the macro process for selecting the optimal cloud service provider(s) to service the user's needs using the software components referred to herein as the “capacity translation module,” “pricing module” and “optimization module.” FIG. 3 illustrates the software architecture used for selecting the optimal cloud service provider(s) to service the user's needs. FIG. 4 is a flowchart of a method for converting the physical capacity into cloud capacity. FIGS. 5A-5B are a flowchart of a method for determining a preferred list of cloud service providers that satisfy the user's requirements and preferences. FIG. 6 is a flowchart of a method for identifying the best cloud service provider from the preferred list of cloud service providers applying the user's goals and constraints.

Referring to FIG. 2, as stated above, FIG. 2 is a diagram illustrating the macro process for selecting the optimal cloud service provider(s) to service the user's needs. The macro process is accomplished by the software components, capacity translation module 201, pricing module 202 and optimization module 203. In one embodiment, these software components may reside in application 104 (FIG. 1).

Capacity translation module 201 converts the physical capacity of the servers in the non-virtualized data center, which is defined in terms of storage capacity, compute capacity and network bandwidth capacity, to the cloud capacity. Storage capacity is the aggregation of the local storage, such as in gigabytes (GB), on all the servers as well as any additional storage for backup and recovery at the user's data center. Compute capacity is the aggregation of the clock rate of the processors (e.g., gigahertz (GHz) and the memory (e.g., random access memory in gigabytes (GB)) on all the servers of the data center. Network bandwidth capacity is the maximum available bandwidth at any point in time at the data center.

Cloud capacity refers to the total compute, storage and network capacity in a virtualized data center. Compute capacity is the expected clock rate of the processors (e.g., gigahertz (GHz) and memory (e.g., random access memory in gigabytes (GB)) expected to be used. Storage capacity is the storage (gigabytes (GB)) that is expected to be used. Network capacity is the bandwidth (megabits per second (Mbps)) expected to be used.

In one embodiment, capacity translation module 201 converts the physical capacity of the servers in the non-virtualized data center to the cloud capacity into standardized units that can be compared and applied to all cloud service providers. In this manner, the various cloud service providers may be able to be compared against one another thereby providing a small list of preferred cloud service providers as discussed below. Additional details regarding capacity translation module 201 is provided below in connection with FIGS. 3 and 4.

Pricing module 202 is configured to use the cloud capacity requirements (provided by capacity translation module 201) in conjunction with a standardized provider catalog 204 to determine a shortened and preferred list of cloud service providers that satisfy the user's requirements and preferences. In one embodiment, the standardized provider catalog 204 includes a listing of cloud service providers as well as the various types of pricing models provided by that provider. For example, some cloud service providers charge a customer's use of the cloud via “packages.” Others charge a customer's use of the cloud via “component pricing” or “virtual machine based pricing.” These will be discussed in further detail below in connection with the discussion of pricing module 202 in FIGS. 5A-5B.

Furthermore, pricing module 202 takes into consideration the different types of clouds (e.g., public versus private) which result in different types of pricing. For example, public cloud pricing are for those cloud service providers that have a public cloud deployment model; whereas, private cloud pricing are for those cloud service providers that have a private cloud deployment model. Additional details regarding pricing module 202 is provided below in connection with FIGS. 3 and 5A-5B.

Optimization module 203 is configured to identify the best service provider and its bill of materials by applying the user's goals and constraints and preferred list of providers. Additional details regarding optimization module 203 is provided below in connection with FIGS. 3 and 6.

Furthermore, the macro process is an iterative process, where the algorithms discussed herein are recalibrated, as indicated by the arrow between optimization module 203 and pricing module 202 in FIG. 2. In one embodiment, such recalibration is performed based on utilization, provider performance and provider capabilities. Whenever the cloud capacity requirements change or when a selected provider fails to meet expectations, a new preferred provider list of cloud service providers may be generated by pricing module 202 and a new optimal cloud service provider(s) may be selected from the preferred provider list by optimization module 203.

The software architecture illustrating the use of these software components for selecting the optimal cloud service provider(s) to service the user's needs is discussed below in connection with FIG. 3.

FIG. 3 illustrates the software architecture used for selecting the optimal cloud service provider(s) to service the user's needs in accordance with an embodiment of the present invention.

Referring to FIG. 3, capacity translation module 201 may include the sub-modules referred to herein as the asset discovery module 301 and the cloud capacity translation engine 302.

Pricing module 202 may include the sub-modules referred to herein as the public/private cloud pricing engine 303, cloud operations pricing engine 304 and the cloud quality of service (QoS) engine 305.

Optimization module 203 may include the sub-module referred to herein as the optimization engine 306.

A detailed description of the functionality of each of the sub-modules of the software architecture as well as their interrelationship will be discussed below in connection with the flowcharts (FIGS. 4-6) describing the process performed by each of the modules of the macro process.

FIG. 4 is a flowchart of a method 400 for converting the physical capacity into cloud capacity in accordance with an embodiment of the present invention.

Referring to FIG. 4, in conjunction with FIGS. 1-3, in step 401, capacity translation module 201 receives an identified server type used in the user's non-virtualized data center. In one embodiment, server types include, but not limited to, application servers, web servers, database servers and security servers. In one embodiment, information pertaining to the server type, as well as other information received by cloud translation module 201 discussed herein, is provided by the user via a user interface tool, such as a wizard.

For each server type (e.g., application server) received, the following steps (step 402-405) are performed.

In step 402, a count for each server type is received by asset discovery engine 301. For example, if the user's non-virtualized data center includes four application servers and two web servers, then the user enters such information via a user interface tool which is received by asset discovery engine 301. It is noted that all cores on a virtual machine will have the same clock speed.

In step 403, a number of processor cores and processes per core for a single server in each server type are received by asset discovery engine 301. For example, if there are two processor cores for each web server, where one processor core has a clock rate of 2.5 GHz and the other processor core has a clock rate of 2.7 GHz, then the user enters such information via a user interface tool which is received by asset discovery engine 301.

In step 404, an amount of memory (e.g., random access memory) of a single server for each server type is received by asset discovery engine 301. For example, if the memory of a web server is 1.7 GB, then the user enters such information via a user interface tool which is received by asset discovery engine 301.

In step 405, a storage capacity for a single server for each server type is received by asset discovery engine 301. For example, if the storage capacity of an application server is 100 GB, then the user enters such information via a user interface tool which is received by asset discovery engine 301.

In step 406, the processor utilization of each server group is received by capacity translation module 201. For example, if the user utilizes 20% of the processer capacity for the web servers as a group, 50% of the processor capacity for the application servers as a group and 10% of the processor capacity for the database servers as a group, then such information is provided by the user via a user interface tool which is received by capacity translation module 201.

In step 407, the memory utilization of each server group is received by capacity translation module 201. For example, if the user utilizes 30% of the memory capacity for the web servers as a group, 30% of the memory capacity for the application servers as a group and 90% of the memory capacity for the database servers as a group, then such information is provided by the user via a user interface tool which is received by capacity translation module 201.

In step 408, the storage utilization of each server group is received by capacity translation module 201. For example, if the user utilizes 70% of the storage capacity for the web servers as a group, 60% of the storage capacity for the application servers as a group and 60% of the storage capacity for the database servers as a group, then such information is provided by the user via a user interface tool which is received by capacity translation module 201.

In step 409, additional storage, such as disk arrays, being used by the user is received by asset discovery engine 301. Such information is provided by the user via a user interface tool which is received by asset discovery engine 301.

In step 410, the utilization of such storage is received by capacity translation module 201. Such information is provided by the user via a user interface tool which is received by capacity translation module 201.

In step 411, the storage breakdown by disk type is received by asset discovery engine 301. For example, the disk space by disk type is received by capacity translation module 201 in step 412 and the disk input/output (I/O) by disk type is received by capacity translation module 201 in step 413. For instance, there are various types of storage, such as flash, fiber and Serial Advanced Technology Attachment (SATA) hard drives. The disk space and input/output requests may be different for each of these types of storage. For example, the flash drives may have a disk space of 10 GB with 2,000 requests/second; whereas, the fiber hard drives have a disk space of 100 GB with 500 requests/second and the SATA hard drives have a disk space of 240 GB with 100 requests/second.

In step 414, the bandwidth used by the non-virtualized data center is received by asset discovery engine 301. Such information is provided by the user via a user interface tool which is received by asset discovery engine 301.

In step 415, the utilization of such bandwidth is received by capacity translation module 201. Such information is provided by the user via a user interface tool which is received by capacity translation module 201.

In step 416, cloud capacity translation engine 302 receives a buffer capacity. Buffer capacity refers to the additional capacity that the user desires that exceeds the required cloud capacity. Such information is provided by the user via a user interface tool which is received by cloud capacity translation engine 302.

In step 417, cloud capacity translation engine 302 generates the processor requirements for the cloud using the following algorithm (EQ 1):

Step 1: ProcReq=(1+buffercap)·Σ_{S∈SVT}ProcReq_ServTypₛ

Step 2: ProcReq_Servtypₛ=qtyₛ·numCoresₛ·procPerCoreₛ·procUtilₛ ∀s ∈SVT

where ProcReq refers to the processor requirements (GHz) on the cloud, bufferCap is the user defined buffer capacity, ProcReq_ServTypₛ is the processor requirements (GHz) on each server type s, qtyₛ is a number of servers s, numCoresₛ is a number of cores in server type s, procPerCoreₛ is a processor clock rate (GHz) per core in server type s, procUtilₛ is a current processor utilization (%) of server type s, and SVT are server types.

In one embodiment, cloud capacity translation engine 302 receives the buffer capacity and the processor utilization of each server group as inputs to generate the processor requirements for the cloud using Equation (EQ 1). In step 418, such processor requirements are displayed by cloud capacity translation engine 302, such as via display 115.

In step 419, cloud capacity translation engine 302 generates the memory requirements for the cloud using the following algorithm (EQ 2):

Step 1: MemReq=(1+buffercap)·Σ_{S∈SVT}MemReq_ServTypₛ

Step 2: MemReq_ServTypₛ=qtyₛ·memₛ·memUtilₛ ∀s ∈SVT

where MemReq refers to the memory requirements (GB) on the cloud, bufferCap is the user defined buffer capacity, MemReq_ServTypₛ are the memory requirements (GB) on each server type s, qtyₛ is the number of servers s, memₛ is the memory (GB) of server type s, and memUtilₛ is the current memory utilization (%) of server type s.

In one embodiment, cloud capacity translation engine 302 receives the buffer capacity and the memory utilization of each server group as inputs to generate the memory requirements for the cloud using Equation (EQ 2). In step 420, such processor requirements are displayed by cloud capacity translation engine 302, such as via display 115.

In step 421, cloud capacity translation engine 302 generates the storage and I/O requirements for the cloud using the following algorithm (EQ 3):

Step 1: StoReq=Σ_{d∈DST}StoReq_DiskTypₛ

Step 2: StoReq_DiskTypₛ=diskSpace_{d}·numDisks_{d} ∀d ∈DST

Step 3: numDisks_{d}−[(1+bufferCap)·(addSto·addStoUti [symbol] +Σ_{S∈SVT}StoReq+ServTypₛ)·(StoBreakdown [symbol] /diskSpace [symbol] )] ∀d ∈DST

Step 4: StoReq_ServTypₛ=qtyₛ·stoₛ·stoUtilₛ ∀s ∈SVT

Step 5: IOReq=Σ_{d∈DST}IOReq_DiskTyp_{d}

Step 6: IOReq_DiskTyp_{d}=diskIO_{d}·numDisks_{d} ∀s ∈DST

where StoReq refer to the storage requirements (GB) on the cloud, StoReq_DiskTyp_{d} are the storage requirements (GB) on each disk type d, diskSpacea is the disk space (GB) of disk type d, NumDisks_{d} is the number of storage disks required of disk type d, DST are the disk types, bufferCap is the user denned buffer capacity, addSto is the additional storage (GB), addStoUtil is the current utilization (%) of additional storage, ServTypₛ is a server of type s, StoBreakdown_{d} is the proportion of storage on disks of type d, qtyₛ is a number of servers s, stoₛ is a local storage (GB) in server s, stoUtils is the current utilization (%) of local storage in server s, SVT are the server types, IOReq_DiskTyp_{d} are the IO requirements (IOps) on each disk type d, diskIO_{d} is the IO per second in disk d, and NumDisks_{d} is the number of storage disks required of disk type d.

In one embodiment, cloud capacity translation engine 302 receives the buffer capacity, the storage utilization of each server group as well as the information received in steps 410, 412 and 413 as inputs to generate the storage and I/O requirements for the cloud using Equation (EQ 3). In step 422, such storage requirements are displayed by cloud capacity translation engine 302, such as via display 115.

In step 423, cloud capacity translation engine 302 generates the bandwidth requirements for the cloud using the following algorithm (EQ 4):

Step 1: BwReq=bw.

where BWReq refers to the bandwidth requirements (Mbps) on the cloud and bw is the current bandwidth.

In one embodiment, cloud capacity translation engine 302 receives the bandwidth utilization as an input to generate the bandwidth requirements for the cloud using Equation (EQ 4). In step 424, such bandwidth requirements are displayed by cloud capacity translation engine 302, such as via display 115.

In step 425, cloud capacity translation engine 302 receives the virtual processor unit (VPU) configuration and the number of virtual processing units per virtual machine (VM). Such information is provided by the user via a user interface tool which is received by cloud capacity translation engine 302. In one embodiment, the VPU configuration refers to the compute capacity (e.g., processor clock rate and memory capacity) per VPU. For example, the processor clock rate per VPU is 2.4 GHz and the memory capacity per VPU is 2.0 GB.

In step 426, cloud capacity translation engine 302 generates the number of VMs and VPUs required for the cloud using the following algorithm (EQ 5):

$$Step 1 \text{:} VPUReq = max \{ [ \begin{matrix}ProcReq \\ procPerVPU\end{matrix} ] \cdot [ \begin{matrix}MemReq \\ memPerVPU ]\end{matrix} \} \\ Step 2 \text{:} VMReq = max [ \begin{matrix}VPUReq \\ VPUPerVM\end{matrix} ]$$

where VPUReq is the number of VPUs (virtual cores) required on the cloud, VMReq is the number of VMs (virtual servers) required on the cloud, ProcReq refers to the processor requirements (GHz) on the cloud, procPerVPU are the processor requirements (GHz) per VPU, MemReq are the memory requirements (GB) on the cloud, memPerVPU are the memory requirements (GB) per VPU, VPUReq is the number of VPUs (virtual cores) required on the cloud, and VPUPer VM is the number of VPUs per VM.

In one embodiment, cloud capacity translation engine 302 receives the VPU configuration and VPUs per VM as well as receives the memory requirements and the processor requirements for the cloud as inputs to generate the VMs and VPUs required for the cloud using Equation (EQ 5). In step 427, such VMs and VPUs required for the cloud are displayed by cloud capacity translation engine 302, such as via display 115.

In step 428, cloud capacity translation engine 302 generates normalized capacity units so as to standardize the capacity requirements for the cloud using the following algorithm (EQ 6):

$$Step 1 \text{:} {cur}_{GCU} = \frac{[ ( \text{?} \cdot BwReq ) \cdot ( \begin{matrix}min ( \begin{matrix}MemReq , \text{?} \cdot \\ ProcReq\end{matrix} ) \cdot \\ min ( \begin{matrix}ProcReq , \text{?} \cdot \\ MemReq\end{matrix} ) + StoReq\end{matrix} ) ]}{1 , 000 , 000}$$

$$\text{?} \text{indicates text missing or illegible when filed}$$

where BWReq refers to the bandwidth requirements (Mbps) on the cloud, MemReq refers to the memory requirements (GB) on the cloud, ProcReq refers to the processor requirements (GHz) on the cloud, and StoReq refers to the storage requirements (GB) on the cloud.

In this manner, cloud capacity translation engine 302 is able to standardize the processor capacity, memory capacity, storage capacity and bandwidth capacity requirements for the cloud thereby allowing such capacity requirements to be compared and applied to all the cloud service providers.

In step 429, the normalized capacity requirements are displayed by cloud capacity translation engine 302, such as via display 115.

In some implementations, method 400 may include other and/or additional steps that, for clarity, are not depicted. Further, in some implementations, method 400 may be executed in a different order presented and that the order presented in the discussion of FIG. 4 is illustrative. Additionally, in some implementations, certain steps in method 400 may be executed in a substantially simultaneous manner or may be omitted.

The capacity requirements may be used by pricing module 202 (FIGS. 2 and 3) to identify a preferred list of cloud service providers that satisfy the user's requirements and preferences as discussed below in connection with FIGS. 5A-5B.

FIGS. 5A-5B are a flowchart of a method 500 for determining a preferred list of cloud service providers that satisfy the user's requirements and preferences in accordance with an embodiment of the present invention.

Referring to FIGS. 5A-5B, in conjunction with FIGS. 1-3, in step 501, pricing module 202 receives an identification (e.g., name) of a cloud service provider, such as from provider catalog 204.

In step 502, a determination is made by pricing module 202 as to whether the deployment model used by the received cloud service provider is public or private. A public deployment model refers to a cloud service provider that provides cloud services via a public cloud; whereas, a private deployment model refers to a cloud service provider that provides cloud services via a private cloud. Such information may be obtained from provider catalog 204.

If the deployment model used by the received cloud service provider is public, then, in step 503, pricing module 202 determines the compute pricing model of the cloud service provider. In one embodiment, the compute pricing models of the cloud service providers may be generalized into three different pricing models, package based pricing, component based pricing and virtual machine based pricing. Package based pricing refers to the selling of cloud services in terms of packages (e.g., one package includes providing a processor clock rate of 1 GHz with a memory size of 2 GB) whose charges are based on the total allocated capacity. Component based pricing refers to the selling of cloud services in terms of components, such as $0.10/GHz/1 hour. Virtual machine based pricing refers to the selling of cloud services in terms of the number of virtual machines required to be used (e.g., 53 virtual machines). In compact based pricing and virtual machine based pricing, charges are based on the usage of capacity provided that user aggressively monitors usage. Since various cloud service providers sell cloud services in terms of different pricing models, pricing module 202 determines the pricing model used by the received cloud service provider.

Upon determining the compute pricing model of the cloud service provider, pricing module 202 sets the compute pricing model of the cloud service provider accordingly. For example, if the compute pricing model of the received cloud service provider is package based pricing, then, in step 504, pricing model 202 sets the compute pricing model as package based pricing. If the compute pricing model of the received cloud service provider is component based pricing, then, in step 505, pricing model 202 sets the compute pricing model as component based pricing. If the compute pricing model of the received cloud service provider is virtual machine based pricing, then, in step 506, pricing model 202 sets the compute pricing model as virtual machine based pricing.

In step 507, pricing module 202 determines the storage pricing model of the cloud service provider. In one embodiment, the storage pricing models of the cloud service providers may be generalized into two different pricing models, package based pricing and component based pricing.

Upon determining the storage pricing model of the cloud service provider, pricing module 202 sets the storage pricing model of the cloud service provider accordingly. For example, if the storage pricing model of the received cloud service provider is package based pricing, then, in step 508, pricing model 202 sets the storage pricing model as package based pricing. If the storage pricing model of the received cloud service provider is component based pricing, then, in step 509, pricing model 202 sets the storage pricing model as component based pricing.

In step 510, public/private cloud pricing engine 303 generates the recurring cost (e.g., maintenance cost/month) for compute (processing and memory) in a public cloud using the following algorithm (EQ 7):

$$Step 1 \text{:} \text{?} {\_CompRecCost}_{v} {blnCompPriceByPack}_{v} \cdot {CompPackRecCost}_{v} + {blnCompPriceCmpn}_{v} \cdot {CompCmpnRecCost}_{v} + {blnCompPriceByVM}_{v} \cdot {CompVMRecCost}_{v} \\ Step 2 \text{:} {CompPacRecCost}_{v} = max \{ \begin{matrix}\frac{\text{?}}{\text{?}} \cdot ( cloudProcUtil \cdot ProcReq ) , \\ \frac{\text{?}}{\text{?}} \cdot ( cloudMemUtil \cdot MemReq ) ,\end{matrix} \} \\ where \\ = \text{?} \text{?} ( cloudProcUtil \cdot ProcReq ) \geq \text{?} ( cloudMemUtil \cdot memReq ) \geq \text{?} \}$$

$$Step 3 \text{:} {CompCmpnRecCost}_{v} = ( procPricePerHr \cdot hrsPerMonth ) \cdot ( CloudProcUtil \cdot ProcReq ) + ( {memPricePerHr}_{v} \cdot hrsPerMonth ) \cdot ( cloudMemUtil \cdot MemReq )$$

$$Step 4 \text{:} {CompVMRecCost}_{v} = \cdot VMReq where$$

$$= \text{?} [ vs \text{:} ProcPerVPU \cdot VPUPerVM \geq \text{?} \cdot MemPerVFU \cdot VPUPerVM \geq {sizeMem}_{vs} ]$$

$$\text{?} \text{indicates text missing or illegible when filed}$$

where Pub_CompRecCostᵥ is the recurring cost of compute in the public cloud of vendor v, blnCompPriceByPackᵥ which is 1 if compute priced by package, 0 otherwise, CompPackRecCostᵥ is the recurring cost of compute when priced by package at vendor v, blnCompPriceByCmpnv which is 1 if compute priced by component, 0 otherwise, blnCompPriceByVMv which is 1 if compute priced by VM, 0 otherwise, CompVMRecCostᵥ is the recurring cost of compute when priced by VM at vendor v, packProcPrice_{cp,v} is the price of processor package cp at vendor v, CP is the compute package, packProc_{cp,v} is the size of processor package cp at vendor v, cloudProcUtil is the expected processor utilization in the cloud, ProcReq refers to the processor requirements (GHz) on the cloud, packProc_{cp,v} is the size of processor package cp at vendor v, cloudMemUtil is the expected memory utilization (%) in the cloud, MemReq refers to the memory requirements (GB) on the cloud, CompCmpnRecCostᵥ is the recurring cost of compute when priced by component at vendor v, procPricePerHrᵥ is the hourly price of processor at vendor v, hrsPerMonth is the average hours per month, claudProcUtil is the expected processor utilization in the cloud, CompVMRecCostᵥ is the recurring cost of compute when priced by VM at vendor v, vmPrice [symbol] is the price per VM of size vs at vendor v, VMReq is the number of VMs (virtual servers) required on the cloud, procPerVPU is the user defined maximum processor per VPU, vpuPerVM is the user defined maximum VPUs per VM, sizeProcᵥₛ is the processor on VM of size vs, memPerVPU is the user defined maximum memory per VPU, vpuPerVM is the user defined maximum VPUs per VM, and sizeMemᵥₛ is the memory on VM of size vs.

In one embodiment, the public/private cloud pricing engine 303 receives the processor, memory and VM requirements for the cloud as inputs to generate the recurring cost (e.g., maintenance cost/month) for compute (processing and memory capacity) in a public cloud.

In step 511, public/private cloud pricing engine 303 generates the recurring cost (e.g., maintenance cost/month) for storage in a public cloud using the following algorithm (EQ 8):

$$Step 1 \text{:} \text{?} = \text{?} \cdot \text{?} + \text{?} \cdot \text{?}$$

$$Step 2 \text{:} {StoPackRecCost}_{v} = ( ) \cdot ( cloudStoUtil \cdot StoReq )$$

$$= \text{?} \{ sp \text{:} CloudStoUtil \cdot StoReq \geq \text{?} \}$$

$$Step 3 \text{:} {StoCmpnRecCost}_{v} = {stoPrice}_{v} \cdot ( cloudStoUtil \cdot StoReq )$$

$$\text{?} \text{indicates text missing or illegible when filed}$$

where Pub_StoRecCostᵥ is the recurring cost of storage in the public cloud of vendor v, blnStoPriceByPackᵥ is 1 if storage priced by package, 0 otherwise, StoPackRecCostᵥ is the recurring cost of storage when priced by package at vendor v, blnStoPriceByCmpnᵥ is 1 if storage priced by component, 0 otherwise, StoCmpnRecCostᵥ is the recurring cost of storage when priced by component at vendor v, packStoPrice_{sp,v} is the price of storage package sp at vendor v, packSto_{sp,v} is the size of storage package sp at vendor v, cloudStoUtil is the expected storage utilization (%) in the cloud, StoReq refers to the storage requirements (GB) on the cloud, SP is the storage package, cloudStoUtil is the expected storage utilization (%) in the cloud, and stoPriceᵥ is the storage price per GB at vendor v.

In one embodiment, the public/private cloud pricing engine 303 receives the storage requirements for the cloud as input to generate the recurring cost (e.g., maintenance cost/month) for storage in a public cloud.

Referring to step 502, if, however, the deployment model for the received cloud service provider is private, then public/private cloud pricing engine 303 calculates the cost of providing a private cloud as discussed in steps 512-516.

In step 512, public/private cloud pricing engine 303 generates the initial compute cost (i.e., the initial cost for processing and memory capacity) in a private cloud using the following algorithm (EQ 9):

Step 1: PVT_CompIniCostᵥ=ChassisIniCostᵥ+BladeIniCostᵥ

Step 2: ChassisIniCostᵥ=chassisPrice [symbol] ·ChassisReqᵥ

Step 3: BladeIniCostᵥ=blade Price [symbol] ·BladsReqᵥ

where Pvt_CompIniCostᵥ is the cost of purchasing compute resources for a private cloud with vendor v, ChassisIniCostᵥ is the cost of purchasing chassis for a private cloud with vendor v, BladeIniCostᵥ is the cost of purchasing blades for a private cloud with vendor v, chassisPrice_{ch,v} is the cost of purchasing chassis type ch at vendor v, ChassisReqᵥ is the number of chassis required when deploying a private cloud with vendor v, BladeIniCostᵥ is the cost of purchasing blades for a private cloud with vendor v, BiadeReqᵥ is the number of blades required when deploying a private cloud with vendor v, and bladePrice_{ch,v} is the cost of purchasing blade on chassis type ch at vendor v.

In one embodiment, the public/private cloud pricing engine 303 receives the chassis requirements and the blade requirements as inputs to generate the initial compute cost (i.e., the initial cost for processing and memory capacity) in a private cloud

In step 513, public/private cloud pricing engine 303 generates the recurring compute cost (e.g., maintenance cost for maintaining processing and memory capacity) in a private cloud using the following algorithm (EQ 10):

$$Step 1 \text{:} {Pvt\_CompRecCost}_{v} = {ChassisRecCost}_{v} + {BladeRecCost}_{v}$$

$$Step 2 \text{:} {ChassisRecCost}_{v} = Chassis \cdot {ChassisReq}_{v}$$

$$Step 3 \text{:} {BladeRecCost}_{v} = \text{?} \cdot {BladeReq}_{v}$$

$$Step 4 \text{:} {BladeReq}_{v} = max \{ [ \frac{ProcReq}{{procPerBlade}_{v}} ] \cdot [ \frac{MemReq}{{memPerBlade}_{v}} ] \}$$

$$= \text{?} \{ ch \text{:} \text{?} {BladeReq}_{v} \}$$

$$Step 5 \text{:} {CassisReq}_{v} = \frac{{BladeReq}_{v}}{\text{?}}$$

$$\overline{ch} = \text{?} \{ \text{?} \}$$

$$\text{?} \text{indicates text missing or illegible when filed}$$

where Pvt_CompRecCostᵥ, is the recurring cost of maintaining compute resources on a private cloud with vendor v, ChassisReqCastᵥ is the recurring cost of maintaining chassis on a private cloud with vendor v, BladeRecCastᵥ is the recurring cost of maintaining blades on a private cloud with vendor v, chassisMaintCost_{ch,v} is the monthly cost of maintaining chassis type ch at vendor v, ChassisReqᵥ is the number of chassis required when deploying a private cloud with vendor v, bladeMaintCost_{ch,v} is a monthly cost of maintaining blade on chassis type ch at vendor v, BladeReqᵥ is a number of blades required when deploying a private cloud with vendor v, ProcReq refers to the processor requirements (GHz) on the cloud, procPerBladeᵥ is processor per blade at vendor v, Memflgfare the memory requirements (GB) on the cloud, memPerBladeᵥ is memory per blade at vendor v, bladeCount_{ch,v} is the maximum number of blades on chassis type ch at vendor v, and CH is the chassis type.

In one embodiment, the public/private cloud pricing engine 303 receives the chassis maintenance cost and blade maintenance cost as inputs to generate the recurring compute cost (e.g., maintenance cost for maintaining processing and memory capacity) in a private cloud.

In step 514, public/private cloud pricing engine 303 generates the initial storage cost (i.e., the initial cost for storage capacity) in a private cloud using the following algorithm (EQ 11):

$$Step 1 \text{:} {PVT\_StoIniCost}_{v} = {StowArrayIniCost}_{v} + {StoDriveIniCost}_{v}$$

$$Step 2 \text{:} {StoArrayIniCost}_{v} = {stoArrayPrice}_{v}$$

$$Step 3 \text{:} {StoDriveIniCost}_{v} = \text{?} \cdot \text{?} \cdot \text{?}$$

$$Step 4 \text{:} {StoDriveReq}_{v} = [ ( \frac{\text{?}}{\text{?}} ) \cdot StoReq ]$$

$$\text{?} \text{indicates text missing or illegible when filed}$$

where Pvt_StoIniCostᵥ is the cost of purchasing storage resources for a private cloud with vendor v, StoArrayIniCostᵥ is the cost of purchasing storage arrays for a private cloud with vendor v, StoDriveIniCostᵥ is the cost of purchasing storage drives for a private cloud with vendor v, stoArrayPriceᵥ is the cost of purchasing a storage array at vendor v, stoDriveDiskSpace_{sd,v} is the disk space (GB) on a single drive of type sd at vendor v, stoDrivePricePerSpace_{sd,v} is the price per GB on a single drive of type sd at vendor v, StoDriveReq_{sd,v} is the number of storage drives sd required for a private cloud with vendor v, stoDrive Breakdown_{sd,v} is the percentage of all storage drives that are of type sd at vendor v, stoDriveMaxUtilᵥ is the maximum acceptable storage utilization at vendor v, StoReq are the storage requirements (GB) on the cloud, and SD is the storage drive.

In one embodiment, the public/private cloud pricing engine 303 receives the storage requirements in the cloud as input to generate the initial storage cost (i.e., the initial cost for storage capacity) in a private cloud.

In step 515, public/private cloud pricing engine 303 generates the recurring compute cost (e.g., maintenance cost for maintaining storage capacity) in a private cloud using the following algorithm (EQ 12):

Step 1: PVT_StoRecCostᵥ=maintPCTᵥ+PVT_StoIniCostᵥ

where Pvt_StoRecCostᵥ is the recurring cost of maintaining storage resources on a private cloud with vendor v, maintPCTᵥ is the percentage of purchase cost estimated for storage maintenance at vendor v, and Pvt_StoIniCostᵥ is the cost of purchasing storage resources for a private cloud with vendor v.

In one embodiment, the public/private cloud pricing engine 303 receives the initial cost of storage in a private cloud as input to generate the recurring compute cost (e.g., maintenance cost for maintaining storage capacity) in a private cloud.

In step 516, public/private cloud pricing engine 303 generates the utilities cost for a private cloud using the following algorithm (EQ 13):

Step 1: PVT_UtilitiesCostᵥ=FloorSpaceCostᵥ·PowerCostᵥ·CoolingCostᵥ

Step 2: FloorSpaceCostᵥ=(2·sqftPerChassisᵥ·floorSpaceCostPerSqftPerMonth)·ChassisReqᵥ

Step 3: PowerCostᵥ=(2·powerCostPerChassisPerMonthᵥ·ChassisReqᵥ

Step 4: CoolingCostᵥ=(2·sqftPerChassisᵥ·coolingCostPerSqftPerMonth)·ChassisReqᵥ

where Pvt_UtilitiesCostᵥ is the recurring cost of utilities when deploying a private cloud with vendor v, FloorSpaceCostᵥ is the recurring cost of floor space when deploying a private cloud with vendor v, PowerCostᵥ is the recurring cost of power when deploying a private cloud with vendor v, CooUngCostv is the recurring cost of cooling servers when deploying a private cloud with vendor v, sqftPerChassisᵥ is the space occupied by a single chassis at vendor v, floorSpaceCostperSqftPerMonth is the average cost of space per month, ChassisReqᵥ is the number of chassis required when deploying a private cloud with vendor v, powerCostPerChassisPerMonthᵥ is the average cost of power per chassis per month at vendor v, and cQolingCostPerSqftPerMonth is the average cost of cooling per month.

In one embodiment, the public/private cloud pricing engine 303 receives the chassis requirements as input to generate the utilities cost for a private cloud.

In step 517, cloud operations pricing engine 304 generates the network recurring cost for maintaining a network (e.g., bandwidth pricing and data transfer pricing) in the cloud. For example, network pricing from cloud service providers may be based on the amount of data transferred or the size of the pipeline. Cloud operations pricing engine 304 generates such recurring costs using the following algorithm (EQ 14):

Step 1: NetworkRecCostᵥblnNetPriceByDedBwᵥ·NetDedBwPerCostᵥ·blnNetPriceByDataTransᵥ+NetDataTransRecCostᵥ

Step 2: NetDedBwRecCostᵥ=dedBwPriceᵥ·BwReq

Step 3: NetDataTransRecCostᵥ=dataTransPrice·(dataTransPerBw·BwReq)

where NetRecCostᵥ is the recurring cost of network at vendor v, blnNetPriceByDedBwᵥ is 1 if network priced by dedicated bandwidth, 0 otherwise, NetDedBWRecCostᵥ is the recurring cost of network when priced by bandwidth at vendor v, blnNetPriceByDataTransᵥ is 1 if network priced by data transfer, 0 otherwise, NedDataTransRecCostᵥ is the recurring cost of network when priced by data transferred at vendor v, dedBwPriceᵥ is the network price per Mbps at vendor v, BWReq are the bandwidth requirements (Mbps) on the cloud, NedDataTransRecCostᵥ is the recurring cost of network when priced by data transferred at vendor v, dataTransPriceᵥ is the network price per GB transferred at vendor v, and dataTransPerBw is the average GB data transferred per Mbps.

In one embodiment, cloud operations pricing engine 304 receives the utilities cost for a private cloud (step 516), the storage pricing model of the cloud service provider (step 508 or 509), the recurring cost for storage in a public cloud (step 511) as well as the capacity requirements 518 generated by capacity translation module 201 as inputs to generate the recurring cost for maintaining a network in the cloud.

In step 519, cloud operations pricing engine 304 generates the operations recurring cost (it is noted that the network recurring cost is separate from the operations recurring cost) for maintaining the operations (e.g., software operation costs, cloud administrative costs, cloud management solution costs) in the cloud using the following algorithm (EQ 15):

$$Step 1 \text{:} {OpsCost}_{v} = {SoftOpsCost}_{v} \cdot {SdminCost}_{v} \cdot {MgmtSolCost}_{v}$$

$$Step 2 \text{:} {SoftOpsCost}_{v} = {softOpsCostPerVM}_{v} \cdot VMReq$$

$$Step 3 \text{:} {AdminCost}_{v} = cloudFTECostPerMonth \cdot \frac{VMReq}{\text{?}}$$

$$Step 4 \text{:} {MgmtSolCost}_{v} = mgmtSolCostPreVM \cdot {VMReq}^{1 - MgmtSolDiscount}$$

$$\text{?} \text{indicates text missing or illegible when filed}$$

where OpsCostᵥ is the recurring cost of operations when deploying cloud at vendor v, SoftOpsCostᵥ is the recurring cost of software operations when deploying cloud at vendor v, AdminOpsCostᵥ is the recurring cost of administrative operations when deploying cloud at vendor v, MgmtSolCostᵥ is the recurring cost of management solutions when deploying cloud at vendor v, softOpsCostPerVMᵥ is the recurring cost of software operations per virtual machine when deploying cloud at vendor v, VMReq is the number of VMs (virtual servers) required on the cloud, cloudFTECostPerMonth is the average cost of cloud FTE per month, vmsManagedPerFTEᵥ is VMs manageable by a single FTE at vendor v, mgmtSolCostPerVM is the average cost of cloud management solution per VM, and MgmtSolCoStᵥ is the recurring cost of management solutions when deploying cloud at vendor v.

In one embodiment, cloud operations pricing engine 304 receives the VM requirements as input to generate the recurring cost for maintaining the operations (e.g., software operation costs, cloud administrative costs, cloud management solution costs) in the cloud.

In step 520, cloud quality of service (QoS) engine 305 generates a quality of service value that indicates how well the particular cloud service provider (obtained from provider catalog 204) is performing. For example, the higher the quality of service value, the better the associated cloud service provider is performing. The generated quality of service value depends on various factors, such as website outages, disk I/O performance, read performance, write performance, compression, compilation, and so forth. In one embodiment, such information may be obtained from a third party that performs benchmark testing on cloud service providers, such as cloudharmony®. In this manner, cloud service providers may be compared amongst each other based on performance testing. In one embodiment, cloud QoS engine 305 generates a quality of service value using the following algorithm (EQ 16):

$$Step 1 \text{:} {CompQoS}_{v} = {ccu}_{v} \cdot {miop}_{v}$$

$$Step 2 \text{:} {StoQoS}_{v} {iop}_{v}$$

$$Step 3 \text{:} {NetQoS}_{v} = \frac{{bw}_{v}}{{Latemcy}_{v}}$$

$$Step 4 \text{:} {InfraQoS}_{v} = {[ ( {CompQoS}_{v} + {StoQoS}_{v} ) \cdot {NetQoS}_{v} ]}^{1 / 2}$$

where CompQoSᵥ is the QoS index for compute at vendor v, ccuᵥ is the cloud compute units of an average server at vendor v (as per cloudharmony®), miopᵥ is the memory I/O units of an average server at vendor v (as per cloudharmony®), StoQoSᵥ is the QoS index for storage at vendor v, iopᵥ is the disk I/O units of an average server at vendor v (as per cloudharmony®), NetQoSᵥ is the QoS index for network at vendor v, bwᵥ is the downlink throughput at vendor v (as per cloudharmony®), latencyᵥ is the average latency at vendor v (as per cloudharmony®), and InfraQoSᵥ is the aggregated QoS index for infrastructure at vendor v (availability SLAs are inherently covered by the latency parameter).

In step 521, pricing module 202 receives additional requirements from the user concerning the cloud services to be provided. For example, the user may require to stream large video files. Other examples include the user requiring a dedicated network, an application needing fast access to storage and so forth. Such information may be provided by the user via a user interface tool which is received by pricing module 202.

In step 522, pricing module 202 receives a location and other preferences from the user concerning the cloud services to be provided. For example, the user may prefer having the cloud infrastructure in North America. Such information may be provided by the user via a user interface tool which is received by pricing module 202.

In step 523, a determination is made by pricing module 202 as to whether the cloud service provider in question satisfies these additional requirements and preferences as received in steps 521 and 522. If not, then in step 524, the provider is not listed in the preferred provider list (selected list of preferred cloud service providers that meet the user's requirements and preferences).

If, however, the cloud service provider in question does satisfy these additional requirements and preferences as received in steps 521 and 522, then, in step 525, the cloud service provider in question is added to the list of preferred providers.

Upon adding the cloud service provider to the list of preferred providers in step 525 or upon not listing the provider in the preferred provider list in step 524, a determination is made by pricing module 202 in step 526 as to whether there are more cloud service providers to analyze that are listed in provider catalog 204.

If there are more cloud service providers to analyze, then pricing module 202 receives an identification (e.g., name) of a subsequent cloud service provider, such as from provider catalog 204 in step 501.

If, however, there are no further cloud service providers to analyze, then, in step 527, pricing module 202 displays, such as via display 115, a preferred provider list (selected list of preferred cloud service providers that meet the user's requirements and preferences) along with the relevant costs computed (e.g., costs computed in steps 510, 511, 512, 513, 514, 515, 516, 517, 519) (e.g., for a public cloud infrastructure, the costs include those computed in steps 510 and 511; whereas, for a private cloud infrastructure, the costs include those computed in steps 512-516) and quality of service value (e.g., quality of service value computed in step 520) for those cloud service providers. In one embodiment, the list of preferred cloud service providers is said to be simulated on display 115, whereby the preferred cloud service providers can be compared side-by-side to one another.

In one embodiment, the preferred provider list can be recalibrated based on monitored data values. The preferred provider list is recalibrated based on monitored data values instead of using outdated results.

In some implementations, method 500 may include other and/or additional steps that, for clarity, are not depicted. Further, in some implementations, method 500 may be executed in a different order presented and that the order presented in the discussion of FIGS. 5A-5B is illustrative. Additionally, in some implementations, certain steps in method 500 may be executed in a substantially simultaneous manner or may be omitted.

A particular cloud service provider that best services the user's needs is selected from the generated preferred provider list using the analysis performed by optimization module 203 as discussed below in connection with FIG. 6.

FIG. 6 is a flowchart of a method 600 for identifying the best cloud service provider applying the user's goals and constraints in accordance with an embodiment of the present invention.

Referring to FIG. 6, in conjunction with FIGS. 1-3, in step 601, a determination is made by optimization module 203 as to whether the user has selected the total recurring monthly cost as the main objective. In one embodiment, the user may be queried as to what is the main factor to be used in selecting the cloud service provider. The main factor may be referred to herein as the “main objective.” For example, the user may be queried as to whether the main objective is the total recurring monthly cost (e.g., total maintenance cost/month), the infrastructure recurring monthly cost (e.g., maintenance cost for maintaining infrastructure/month) or the quality of service value. Once the user has selected one of these factors as the main objective, the user may then provide the constraints for the other factors. For instance, if the user selected the total maintenance cost/month as being the main objective, then the user would provide the constraints for the other factors, such as having the infrastructure recurring monthly cost being ≦$10,000/month and the quality of service value being ≧5. Such information may be provided by the user via a user interface tool which is received by optimization module 203. Upon receiving such information, optimization engine 306 will select the provider that meets these constraints that also has the lowest total maintenance cost/month (main objective for the user). In this manner, the best cloud service provider to service the user's needs is selected as discussed further below.

While the present invention discusses herein the factors of the total recurring monthly cost (e.g., total maintenance cost/month), the infrastructure recurring monthly cost (e.g., maintenance cost for maintaining infrastructure/month) and the quality of service value as being used to select the optimal cloud service provider(s), the principles of the present invention are not limited to the use of such factors. Other factors may be used in selecting the optimal cloud service provider(s) to service the user's needs.

Referring to step 601, if the user did select the total recurring monthly cost as the main objective, then, in step 602, optimization engine 306 selects the total recurring monthly cost as the main objective. In step 603, optimization engine 306 receives the constraints on the other two factors, such as the maximum infrastructure recurring monthly cost and the minimum quality of service value.

If, however, the user did not select the total recurring monthly cost as the main objective, then, in step 604, a determination is made by optimization module 203 as to whether the user has selected the infrastructure recurring monthly cost as the main objective.

If the user selected the infrastructure recurring monthly cost as the main objective, then, in step 605, optimization engine 306 selects the infrastructure recurring monthly cost as the main objective. In step 606, optimization engine 306 receives the constraints on the other two factors, such as the maximum total recurring monthly cost and the minimum quality of service value.

If, however, the user did not select the infrastructure recurring monthly cost as the main objective, then, in step 607, optimization engine 306 selects the quality of service as the main objective. In step 608, optimization engine 306 receives the constraints on the other two factors, such as the maximum total recurring monthly cost and the maximum infrastructure recurring monthly cost.

In step 609, optimization engine 306 selects the optimal cloud service provider(s) that will best service the user's needs using the user's goals (e.g., main objective) and constraints. Optimization engine 306 selects the optimal cloud service provider(s) using the following algorithm (EQ 17):

$$MinbinObjRecCost ( \text{?} \cdot {X}_{v} ) + \text{?} binObjInfraRecCost ( \text{?} \cdot {X}_{v} ) - binObjQos ( \text{?} {QoS}_{v} \cdot {X}_{v} )$$

$$Step 2 : ( 1 - binObjRecCost ) \cdot ( {\sum }_{v ∈ V} {RecCost}_{v} \cdot {X}_{v} ) \leq maxRecCost ( 1 - binObjInfraCost ) \cdot ( {\sum }_{v ∈ V} {InfraRecCost}_{v} \cdot {X}_{v} ) \leq maxInfraRecCost ( {\sum }_{v ∈ V} {QoS}_{v} - {X}_{v} ) \geq minQoS ( 1 - binObjQos )$$

$$\text{?} \text{indicates text missing or illegible when filed}$$

where blnObjRecCost is 1 if minimizing recurring cost is the objective, 0 otherwise, RecCOstᵥ is the recurring cost of infrastructure, operations and utilities when deploying a cloud with vendor v, Xᵥ is 1 if vendor v is selected, 0 otherwise, maxRecCost is the maximum budget for recurring cost, maxInfraRecCost is the maximum budget for infrastructure recurring cost, blnObjInfraRecCost is 1 if minimizing infrastructure recurring cost is the objective, 0 otherwise, InfraRecCostᵥ is the recurring cost of compute, storage, network when deploying a cloud with vendor v, blnObjQoS is 1 if maximizing QoS is the objective, 0 otherwise, minQoS is the minimum acceptable QoS, and blnObjQoS is 1 if maximizing QoS is the objective, 0 otherwise.

In one embodiment, optimization engine 306 receives the provider list 610 generated by pricing module 202 as well as the selected main objective and constraints from the user as inputs to determine the optimal cloud service provider(s). In step 611, optimization module 203 displays the optimal cloud service provider(s) to service the user's needs, such as on display 115.

Upon the selection and display of the optimal cloud service provider(s), the selection may be recalibrated as illustrated and discussed in connection with FIG. 2.

In step 612, optimization module 203 receives an order placement with the selected provider(s).

In some implementations, method 600 may include other and/or additional steps that, for clarity, are not depicted. Further, in some implementations, method 600 may be executed in a different order presented and that the order presented in the discussion of FIG. 6 is illustrative. Additionally, in some implementations, certain steps in method 600 may be executed in a substantially simultaneous manner or may be omitted.

By using the principles of the present invention, the optimal cloud service to service the user's needs may be identified for the user. As discussed above, the principles of the present invention implement a dynamic planning and sourcing through a standardized global provider catalog 204. Furthermore, since this is a dynamic software application, solutions can be recalibrated to provide up-to-date solutions that best meet the user's expectations.

Additionally, the algorithms discussed herein consolidate utilized capacity into reserved cloud capacity while allowing access to more through bursting. The algorithms discussed herein consider utilization and discount current capacity to cloud capacity.

In addition, the principles of the present invention standardize the provider pricing models and allow for side-by-side provider comparison, such as showing the providers listed in the preferred provider list (generated by pricing module 202) side-by-side to one another. Through optimization engine 305, the best provider is determined based on constraints, such as cost, agility and quality of service.

Furthermore, the algorithms discussed herein are designed to automatically standardize and estimate provider process thus reducing computation time. Further, the algorithms are automatically recalibrated (due to the fact that the algorithms are data driven) with the best provider based on up-to-date utilization and performance.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for selecting the optimal cloud service provider(s) to service a user's needs, the method comprising:
converting a physical capacity of servers in a non-virtualized data center into a cloud capacity;
pricing said cloud capacity based on a catalog of providers to generate a list of cloud service providers that is standardized;
simulating said list of cloud service providers;
receiving constraints on one or more of costs, agility and quality of service;
selecting, by a processor, via an optimization algorithm one or more cloud service providers from said list of cloud service providers based on said received constraints; and
recalibrating said selection of one or more cloud service providers from said list of cloud service providers.

2. The method as recited in claim 1 further comprising:
receiving a main objective for said user to be used in selecting said cloud service provider from said list of cloud service providers.

3. The method as recited in claim 2, wherein said main objective and said constraints comprise a total recurring monthly cost, an infrastructure recurring monthly cost and a quality of service value.

4. The method as recited in claim 1 further comprising:
receiving a count for each server type;
receiving a number of processor cores and processes per core for a server in each server type;
receiving an amount of memory for said server in each server type; and
receiving a storage capacity for said server in each server type.

5. The method as recited in claim 4, wherein said server type comprises one or more of the following: application server, web server, database server and security server.

6. The method as recited in claim 4 further comprising:
receiving processor utilization, memory utilization and storage utilization of each server group.

7. The method as recited in claim 1 further comprising:
receiving a bandwidth and utilization of said bandwidth; and
generating bandwidth requirements for a cloud environment using said received bandwidth and said utilization of said bandwidth.

8. The method as recited in claim 1 further comprising:
receiving a buffer capacity that exceeds said cloud capacity;
receiving a number of processor cores and processes per core for a server in each server type;
receiving a processor utilization of each server group; and
generating processor requirements for a cloud environment using said
received buffer capacity, said received number of processor cores and processes per core for said server in each server type, and said received processor utilization of each server group.

9. The method as recited in claim 1 further comprising:
receiving a buffer capacity that exceeds said cloud capacity;
receiving an amount of memory for a server in each server type;
receiving a memory utilization of each server group; and
generating memory requirements for a cloud environment using said received buffer capacity, said received amount of memory for said server in each server type, and said received memory utilization of each server group.

10. The method as recited in claim 1 further comprising:
receiving a buffer capacity that exceeds said cloud capacity;
receiving a storage capacity for a server in each server type;
receiving a storage utilization of each server group; and
generating storage requirements for a cloud environment using said received buffer capacity, said received storage capacity for said server in each server type, and said received storage utilization of each server group.

11. The method as recited in claim 1 further comprising:
receiving a virtual processor unit configuration and a number of virtual processing units per virtual machine;
receiving processor requirements for a cloud environment;
receiving memory requirements for said cloud environment; and
generating a number of virtual machine and virtual processing units required for said cloud environment using said received virtual processor unit configuration and said number of virtual processing units per virtual machine, said received processor requirements and said received memory requirements.

12. The method as recited in claim 1 further comprising:
receiving processor requirements for a cloud environment;
receiving memory requirements for said cloud environment;
receiving storage requirements for said cloud environment;
receiving bandwidth requirements for said cloud environment; and
normalizing said processor requirements, said memory requirements, said storage requirements and said bandwidth requirements for said cloud environment.

13. The method as recited in claim 1 further comprising:
determining a compute pricing model for providers listed in said list of cloud service providers; and
determining a storage pricing model for providers listed in said list of cloud service providers.

14. The method as recited in claim 13, wherein said compute pricing model comprises: packaged based pricing, component based pricing and virtual machine based pricing.

15. The method as recited in claim 13, wherein said storage pricing model comprises: packaged based pricing and component based pricing.

16. The method as recited in claim 1 further comprising:
receiving a storage pricing model of a provider listed in said list of cloud service providers;
generating a recurring cost for storage in a public cloud environment using said storage pricing model of said provider; and
generating a recurring cost for maintaining a network in said cloud environment using said generated recurring cost for storage and said cloud capacity.

17. The method as recited in claim 1 further comprising:
generating an initial cost for one or more of the following: storage capacity, processing and memory capacity.

18. The method as recited in claim 1 further comprising:
generating a recurring cost for maintaining operations of a network in a cloud environment using virtual machine requirements for said cloud environment.

19. The method as recited in claim 1 further comprising:
receiving requirements and preferences from said user concerning cloud services to be provided; and
including cloud service providers that meet said requirements and preferences in said list of cloud service providers.

20. The method as recited in claim 1 further comprising:
selecting via said optimization algorithm said one or more cloud service providers from said list of cloud service providers based on said received constraints followed by order placement with said selected one or more cloud service providers.

21. A computer program product embodied in a computer readable storage medium for selecting the optimal cloud service provider(s) to service a user's needs, the computer program product comprising the programming instructions for:
converting a physical capacity of servers in a non-virtualized data center into a cloud capacity;
pricing said cloud capacity based on a catalog of providers to generate a list of cloud service providers that is standardized;
simulating said list of cloud service providers;
receiving constraints on one or more of costs, agility and quality of service;
selecting via an optimization algorithm one or more cloud service providers from said list of cloud service providers based on said received constraints; and
recalibrating said selection of one or more cloud service providers from said list of cloud service providers.

22. The computer program product as recited in claim 21 further comprising the programming instructions for:
receiving a main objective for said user to be used in selecting said cloud service provider from said list of cloud service providers.

23. The computer program product as recited in claim 22, wherein said main objective and said constraints comprise a total recurring monthly cost, an infrastructure recurring monthly cost and a quality of service value.

24. The computer program product as recited in claim 21 further comprising the programming instructions for:
receiving a count for each server type;
receiving a number of processor cores and processes per core for a server in each server type;
receiving an amount of memory for said server in each server type; and
receiving a storage capacity for said server in each server type.

25. The computer program product as recited in claim 24, wherein said server type comprises one or more of the following: application server, web server, database server and security server.

26. The computer program product as recited in claim 24 further comprising the programming instructions for:
receiving processor utilization, memory utilization and storage utilization of each server group.

27. The computer program product as recited in claim 21 further comprising the programming instructions for:
receiving a bandwidth and utilization of said bandwidth; and
generating bandwidth requirements for a cloud environment using said received bandwidth and said utilization of said bandwidth.

28. The computer program product as recited in claim 21 further comprising the programming instructions for:
receiving a buffer capacity that exceeds said cloud capacity;
receiving a number of processor cores and processes per core for a server in each server type;
receiving a processor utilization of each server group; and
generating processor requirements for a cloud environment using said received buffer capacity, said received number of processor cores and processes per core for said server in each server type, and said received processor utilization of each server group.

29. The computer program product as recited in claim 21 further comprising the programming instructions for:
receiving a buffer capacity that exceeds said cloud capacity;
receiving an amount of memory for a server in each server type;
receiving a memory utilization of each server group; and
generating memory requirements for a cloud environment using said received buffer capacity, said received amount of memory for said server in each server type, and said received memory utilization of each server group.

30. The computer program product as recited in claim 21 further comprising the programming instructions for:
receiving a buffer capacity that exceeds said cloud capacity;
receiving a storage capacity for a server in each server type;
receiving a storage utilization of each server group; and
generating storage requirements for a cloud environment using said received buffer capacity, said received storage capacity for said server in each server type, and said received storage utilization of each server group.

31. The computer program product as recited in claim 21 further comprising the programming instructions for:
receiving a virtual processor unit configuration and a number of virtual processing units per virtual machine;
receiving processor requirements for a cloud environment;
receiving memory requirements for said cloud environment; and
generating a number of virtual machine and virtual processing units required for said cloud environment using said received virtual processor unit configuration and said number of virtual processing units per virtual machine, said received processor requirements and said received memory requirements.

32. The computer program product as recited in claim 21 further comprising the programming instructions for:
receiving processor requirements for a cloud environment;
receiving memory requirements for said cloud environment;
receiving storage requirements for said cloud environment;
receiving bandwidth requirements for said cloud environment; and
normalizing said processor requirements, said memory requirements, said storage requirements and said bandwidth requirements for said cloud environment.

33. The computer program product as recited in claim 21 further comprising the programming instructions for:
determining a compute pricing model for providers listed in said list of cloud service providers; and
determining a storage pricing model for providers listed in said list of cloud service providers.

34. The computer program product as recited in claim 33, wherein said compute pricing model comprises: packaged based pricing, component based pricing and virtual machine based pricing.

35. The computer program product as recited in claim 33, wherein said storage pricing model comprises: packaged based pricing and component based pricing.

36. The computer program product as recited in claim 21 further comprising the programming instructions for:
receiving a storage pricing model of a provider listed in said list of cloud service providers;
generating a recurring cost for storage in a public cloud environment using said storage pricing model of said provider; and
generating a recurring cost for maintaining a network in said cloud environment using said generated recurring cost for storage and said cloud capacity.

37. The computer program product as recited in claim 21 further comprising the programming instructions for:
generating an initial cost for one or more of the following: storage capacity, processing and memory capacity.

38. The computer program product as recited in claim 21 further comprising the programming instructions for:
generating a recurring cost for maintaining operations of a network in a cloud environment using virtual machine requirements for said cloud environment.

39. The computer program product as recited in claim 21 further comprising the programming instructions for:
receiving requirements and preferences from said user concerning cloud services to be provided; and
including cloud service providers that meet said requirements and preferences in said list of cloud service providers.

40. The computer program product as recited in claim 21 further comprising the programming instructions for:
selecting via said optimization algorithm said one or more cloud service providers from said list of cloud service providers based on said received constraints followed by order placement with said selected one or more cloud service providers.

41. A system, comprising:
a memory unit for storing a computer program for selecting the optimal cloud service provider(s) to service a user's needs; and
a processor coupled to said memory unit, wherein said processor, responsive to said computer program, comprises:
circuitry for converting a physical capacity of servers in a non-virtualized data center into a cloud capacity;
circuitry for pricing said cloud capacity based on a catalog of providers to generate a list of cloud service providers that is standardized;
circuitry for simulating said list of cloud service providers;
circuitry for receiving constraints on one or more of costs, agility and quality of service;
circuitry for selecting via an optimization algorithm one or more cloud service providers from said list of cloud service providers based on said received constraints; and
circuitry for recalibrating said selection of one or more cloud service providers from said list of cloud service providers.

42. The system as recited in claim 41, wherein said processor further comprises:
circuitry for receiving a main objective for said user to be used in selecting said cloud service provider from said list of cloud service providers.

43. The system as recited in claim 42, wherein said main objective and said constraints comprise a total recurring monthly cost, an infrastructure recurring monthly cost and a quality of service value.

44. The system as recited in claim 41, wherein said processor further comprises:
circuitry for receiving a count for each server type;
circuitry for receiving a number of processor cores and processes per core for a server in each server type;
circuitry for receiving an amount of memory for said server in each server type; and
circuitry for receiving a storage capacity for said server in each server type.

45. The system as recited in claim 44, wherein said server type comprises one or more of the following: application server, web server, database server and security server.

46. The system as recited in claim 44, wherein said processor further comprises:
circuitry for receiving processor utilization, memory utilization and storage utilization of each server group.

47. The system as recited in claim 41, wherein said processor further comprises:
circuitry for receiving a bandwidth and utilization of said bandwidth; and
circuitry for generating bandwidth requirements for a cloud environment using said received bandwidth and said utilization of said bandwidth.

48. The system as recited in claim 41, wherein said processor further comprises:
circuitry for receiving a buffer capacity that exceeds said cloud capacity;
circuitry for receiving a number of processor cores and processes per core for a server in each server type;
circuitry for receiving a processor utilization of each server group; and
circuitry for generating processor requirements for a cloud environment using said received buffer capacity, said received number of processor cores and processes per core for said server in each server type, and said received processor utilization of each server group.

49. The system as recited in claim 41, wherein said processor further comprises:
circuitry for receiving a buffer capacity that exceeds said cloud capacity;
circuitry for receiving an amount of memory for a server in each server type;
circuitry for receiving a memory utilization of each server group; and
circuitry for generating memory requirements for a cloud environment using said received buffer capacity, said received amount of memory for said server in each server type, and said received memory utilization of each server group.

50. The system as recited in claim 41, wherein said processor further comprises:
circuitry for receiving a buffer capacity that exceeds said cloud capacity;
circuitry for receiving a storage capacity for a server in each server type;
circuitry for receiving a storage utilization of each server group; and
circuitry for generating storage requirements for a cloud environment using said received buffer capacity, said received storage capacity for said server in each server type, and said received storage utilization of each server group.

51. The system as recited in claim 41, wherein said processor further comprises:
circuitry for receiving a virtual processor unit configuration and a number of virtual processing units per virtual machine;
circuitry for receiving processor requirements for a cloud environment;
circuitry for receiving memory requirements for said cloud environment; and
circuitry for generating a number of virtual machine and virtual processing units required for said cloud environment using said received virtual processor unit configuration and said number of virtual processing units per virtual machine, said received processor requirements and said received memory requirements.

52. The system as recited in claim 41, wherein said processor further comprises:
circuitry for receiving processor requirements for a cloud environment;
circuitry for receiving memory requirements for said cloud environment;
circuitry for receiving storage requirements for said cloud environment;
circuitry for receiving bandwidth requirements for said cloud environment; and
circuitry for normalizing said processor requirements, said memory requirements, said storage requirements and said bandwidth requirements for said cloud environment.

53. The system as recited in claim 41, wherein said processor further comprises:
circuitry for determining a compute pricing model for providers listed in said list of cloud service providers; and
circuitry for determining a storage pricing model for providers listed in said list of cloud service providers.

54. The system as recited in claim 53, wherein said compute pricing model comprises: packaged based pricing, component based pricing and virtual machine based pricing.

55. The system as recited in claim 53, wherein said storage pricing model comprises: packaged based pricing and component based pricing.

56. The system as recited in claim 41, wherein said processor further comprises:
circuitry for receiving a storage pricing model of a provider listed in said list of cloud service providers;
circuitry for generating a recurring cost for storage in a public cloud environment using said storage pricing model of said provider; and
circuitry for generating a recurring cost for maintaining a network in said cloud environment using said generated recurring cost for storage and said cloud capacity.

57. The system as recited in claim 41, wherein said processor further comprises:
circuitry for generating an initial cost for one or more of the following: storage capacity, processing and memory capacity.

58. The system as recited in claim 41, wherein said processor further comprises:
circuitry for generating a recurring cost for maintaining operations of a network in a cloud environment using virtual machine requirements for said cloud environment.

59. The system as recited in claim 41, wherein said processor further comprises:
circuitry for receiving requirements and preferences from said user concerning cloud services to be provided; and
circuitry for including cloud service providers that meet said requirements and preferences in said list of cloud service providers.

60. The system as recited in claim 41, wherein said processor further comprises:
circuitry for selecting via said optimization algorithm said one or more cloud service providers from said list of cloud service providers based on said received constraints followed by order placement with said selected one or more cloud service providers.
